(19) United States
(12) Patent Application Publication
(10) Pub. No.: US 2019/0348754 A1
(43) Pub. Date: Nov. 14, 2019

(54) SMART ANTENNA FOR IN-VEHICLE APPLICATIONS THAT CAN BE INTEGRATED WITH TCU AND OTHER ELECTRONICS

(71) Applicant: Antenum, LLC, Windham, NH (US)

(72) Inventors: John T. Apostolos, Lyndeborough, NH (US); William Mouyos, Windham, NH (US); James D. Logan, Candia, NH (US); Sean Hallinan, Merrimack, NH (US)

(21) Appl. No.: 16/179,069

(22) Filed: Nov. 2, 2018

Related U.S. Application Data
(60) Provisional application No. 62/581,110, filed on Nov. 3, 2017.
(60) Provisional application No. 62/584,966, filed on Nov. 13, 2017.
(60) Provisional application No. 62/733,162, filed on Sep. 19, 2018.
(60) Provisional application No. 62/624,914, filed on Feb. 1, 2018.

(51) Int. Cl. H01Q 1/32; H01Q 21/29; H01Q 21/06

(52) U.S. Cl. CPC H01Q 1/3275; H01Q 21/065; H01Q 21/29

(57) ABSTRACT

A low profile, conformal antenna assembly provides wide bandwidth, orientation dependent and directional operation via volumetric radiating elements that are diposed over a cavity. The volumetric antenna elements may be further controlled by embedded inductive or capacitive components and/or surrounded by frequency-selective components. An optional AM/FM radiating structure is provided by a conductive wire helix disposed within the cavity. The antenna assembly may be integrated with system and control, conversion, amplification and/or processing electronics in a single enclosure or tightly coupled enclosure space. Integrating the antenna subassembly with an electronics subassembly in the same enclosure eliminates the requirement for discrete RF signal connections reduces associated costs, and avoides signal losses in the connections to multiple vehicle systems. The antenna can be mounted to the inside surface of glass in a vehicle.

### CROSS REFERENCE TO RELATED APPLICATIONS

This patent application claims priority to co-pending U.S. Provisional Patent Application Ser. No. 62/581,110 filed Nov. 3, 2017 entitled “MIMO Directional Antenna Integrated with Vehicle TCU” (Attorney Docket 111052-0096R), U.S. Provisional Application Ser. No. 62/584,966 filed Nov. 13, 2017 entitled “Low Profile Antenna—Conformal” (Attorney Docket No. 111052-0097R), U.S. Provisional Application Ser. No. 62/733,162 filed Sep. 19, 2018 entitled “Enahanced Conformal Low Profile Antenna” (Attorney Docket No. 111052-0097R1), and U.S. Provisional Patent Application Ser. No. 62/624,914 filed Feb. 1, 2018 entitled “Smart Volumetric Antenna for Vehicular Applications” (Attorney Docket No. ANT001). The entire contents of each of the above-referenced patent applications are hereby incorporated by reference herein.

### BACKGROUND

### Technical Field

This patent application relates generally to in-vehicle communication systems and in particular to a low-profile, conformal, directional, modular antenna that may be intetraged with a Telematics Control Unit (TCU) or similar vehicle electronics controller(s).

### Background

Antennas have long been attached to and even embedded in certain portions of vehicles. One common approach implements the antenna as a conductive wire trace deposited onto a rear window. However, window antennas have drawbacks, such as reduced visibility out of the window, directional sensitivity, and degradation due to sun exposure over time. So-called shark fin antennas have come into use since the late 1990's. These roof mounted assemblies, approximately 6 inches or so in length, are encased in an aerodynamic or other visually pleasing housing. However, shark fins protrude from the vehicle body and their shortened length sometimes to compromise reception.

A directional antenna formed of multiple radiating elements can provide a concentrated signal or beam in a selected direction to increase antenna gain and directivity. But since vehicle design is often dictated by styling, the presence of numerous protruding antennas is not desirable. Directional antenna arrays often have complex shapes and large size, making them difficult to package in a vehicle.

It is also preferable to conceal the antenna components to protect them from the elements and to preserve vehicle aesthetics. In order to conceal the antenna, it might be considered to be desirable to locate the radiating elements beneath or conformal to the sheet metal body of a vehicle. However, the presence of large expanses of sheet metal is commonly thought to adversely affect antenna performance.

In addition, multiple components are required to receive and process the RF (Radio Frequency) signals for use by the antenna and various systems installed in transportation vehicles. RF signals are received at low levels and connecting them in their RF form must be accomplished using high cost, high quality connectors and cabling. Loss of signal strength and integrity occurs combining these signals, received by a multi-band antenna, into a single digital bus form. The digital bus provides connection to a TCU (Telecommunications Control Unit), allowing the data to be used by multiple systems distributed within the vehicle without the associated losses encountered with the distribution of discrete RF signals.

### SUMMARY

In one implementation, a low profile antenna structure in accordance with the teachings herein consists of one or more planar planar radiators disposed in a plane and positioned over a cavity. The planar radiators are typically rectangular in shape. Capacitive, inductive, or passively reconfigurable surface impedances may optionally operate as a frequency dependent couplings between the radiators and nearby ground plane(s) or ground connections. The surrounding ground plane(s) or ground connections elements may not be necessary, but if they are, they can be further provided by conductive cavity walls rather than a ground plane.

The low profile planar antenna structure may be suitable for operating across a wide range of frequencies including 3G/4G/LTE cellular, Wi-Fi, Bluetooth, GPS, satellite radio, and even proposed 5G wireless and vehicle-to-vehicle bands. In some implementations, a helical wire coil may be disposed within the cavity, either by itself, or together with the array of planar radiators. The helical coil provides operation in another frequency band, such as the AM and/or FM band.

It is now possible to provide integration of the antenna components and a TCU (or other control electronics) into a single enclosure or tightly coupled enclosure space, eliminating the requirement for, and risks, of discrete connections to multiple vehicle systems. In one embodiment, a device integrates the antenna system and control, conversion, amplification and processing electronics into the single enclosure or tightly coupled enclosure space. Processing of RF signals occurs within the antenna itself or within a single module integrated with the antenna.

If space or mounting requirements exceed the area required by the antenna, an integrated connection that does not use any cables may be made between the antenna housing and the electronics to create the single integrated unit.

The low-profile structure is particularly suited for location on or within close proximity to the sheet metal of a vehicle structure, such as a roof or trunk. However, since the antenna does not rely on a ground plane for it to perform properly (as does a prior art monopole type antenna), it can now also be mounted to other surfaces, such as an inside surface of a glass roof. This allows for the designers the freedom of installing the antenna without the typical burden of adding a metallic surround to ensure the antenna performs properly.

In some embodiments, the planar antenna array may include an orientation-independent antenna (ORIAN) subsystem and associated beamforming circuits to provide polarization-independent determination of location and other functions.

### BRIEF DESCRIPTION OF THE DRAWINGS

The description below refers to the accompanying drawings, of which:

FIG. 1 shows a multi-band, conformal, planar antenna assembly, which in some embodiments integrates electronics with the antenna components in the same device or housing, and has a connector which may transport digital control and data signals.

FIGS. 2A, 2B and 2C are isometric and exploded views of the multi-band, low-profile antenna array.

FIG. 3 illustrates the low-profile conformal antenna structure embedded in the roof of a vehicle.

FIG. 4 is another low-profile conformal antenna structure using a different type of planar rectangular radiator array.

FIG. 5 is yet another implemention where the elements of the planar array are rotated with respect to the cavity walls.

FIG. 6 is an implementation of the planar array of radiators using capacitive couplers.

FIG. 7 is an implementation of the planar array using inductive couplers.

FIG. 8 is a photograph of an implementation using eigen arcs.

FIG. 9A is a combining network and FIG. 9B an antenna pattern.

FIG. 10 shows another low-profile conformal antenna structure, which includes AM/FM radiator provided by a wire helix disposed within a cavity.

FIG. 11 is an example prior art vehicle and its electronics subsystems;

FIG. 12 is a block diagram of the antenna assembly described herein, where a TCU, other electronics, and/or a beamformer are packages in the same enclosure with the modular antenna.

FIG. 13 illustrates a modular antenna and electronics unit.

FIG. 14 illustrates a completely integrated antenna and electronics unit.

FIG. 15 illustrates a volumetric antenna surrounded by RF and digital electronics.

### DETAILED DESCRIPTION OF AN EMBODIMENT

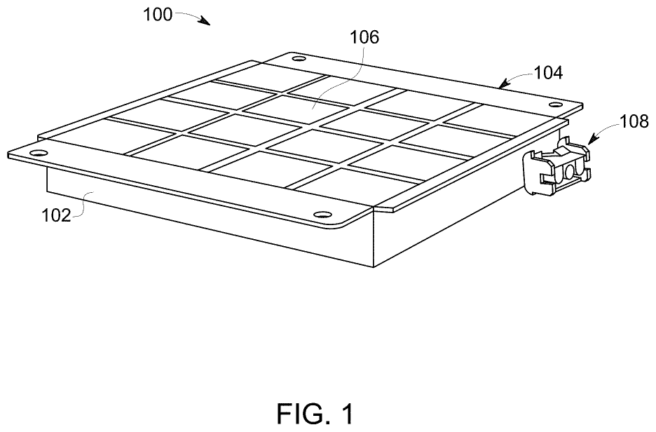

FIG. 1 is an isometric view of a low profile, conformal antenna assembly 100. The assembly 100 consists of a housing 102 that defines a cavity, and a top planar surface 104 disposed above the cavity. In this arrangement, a wire helix is disposed within the cavity. The top planar surface 104 of the structure has two or more planar conductors 106 (in one example these are rectangular patch antenna elements). In some embodiments, shown and described in more detail below, radio frequency, analog, and digital electronics are also integrated within the housing 102, such as adjacent the cavity. A connector 108 provides signal connections to and from these integrated electroncs.

The assembly 100 can provide a volumetric, multi-function, multi-band antenna subsystem where an integrated control unit receives and distributes signals to and from the antenna unit. For example, electronics integrated with the antenna may provide signal processing, control and distribution. Signal losses are thus minimized by elimination of losses contributed by interconnections.

Antenna Array Subassembly

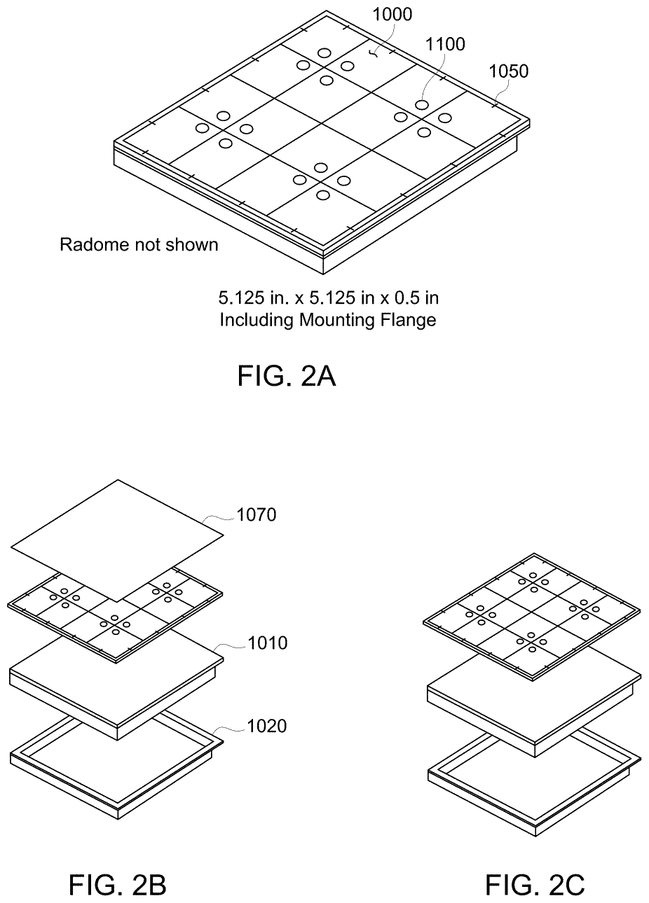

The antenna array 106 is suitable for operating across a wide range of frequencies including AM/FM, 3G/4G, cellular, Wi-Fi, Bluetooth, GPS, satellite radio, and even proposed 5G wireless and vehicle-to-vehicle bands. The exploded views of FIGS. 2A, 2B and 2C show one such implementation, where the top surface includes an array of planar rectangular radiators disposed over the cavity. One such planar array structure consists of a number of planar conductive surfaces or patches 1000 disposed in or near a top reference plane 1010 over the cavity 1020. In this particular implementation, the planar radiators are arranged in 4×4 arrays (e.g., a total of 16 patch radiators). However, as will be explained below, other planar array configurations are possible. An optional radiation-transparent cover or radome 1070 may be placed over the patches 1000.

The cavity 1020 may be defined by vertical conductive walls of a housing such as was shown in FIG. 1; optionally, the cavity may incorporate components of a vehicle body such as a roof or a trunk.

In this implementation, a number of frequency selective coupling elements 1050 connect the patches 1000 to one another and/or to the surrounding vehicle surfaces or cavity walls. These frequency selective couplings are for tuning the structure across many different frequency bands. For example, in one embodiment the structure shown in FIGS. 2A, 2B, 2C can cover the AM/FM, 3G and 4G cellular, satellite, Wi-Fi, Bluetooth, GPS, 5G cellular and vehicle to vehicle (V2V) frequency bands.

The frequency selective couplings may be implemented using meander line structures. The meander line structures may take various forms such as interconnected, alternating, high and low impedance sections disposed over a conductive surface. The frequency dependent couplings may also take the form of a Variable Impedance Transmission Line (VITL) that consists of a meandering metallic transmission line with gradually decreasing section lengths, with interspersed dielectric portions to isolate the conductive segments. Specific embodiments of the VITL structures may further include electroactive actuators that alter the spacing between dielectric and metal layers to provide a Tunable Variable Impedance Transmission Line (TVITL) as per issued U.S. Pat. No. 9,147,936.

In the illustrated configuration, the 16 individual patches 1000 are arranged in four groups of four radiators to provide for orientation independent volumetric antenna arrays. This type of antenna array is described in our previous patents such as U.S. Pat. No. 9,147,936 entitled “Low-Profile, Very Wide Bandwidth Aircraft Communications Antennas Using Advanced Ground-Plane Techniques,” as well as U.S. patent application Ser. No. 15/362,988 filed Nov. 29, 2016 entitled “Super Directive Array of Volumetric Antenna Elements for Wireless Device Applications”, the entire contents of all of which are hereby incorporated by reference.

As shown in FIGS. 2A, 2B, and 2C, each group of four adjacent patches is itself a “quad” or 4-element subassembly that is an Orientation Independent volumetric antenna. The 16 patches may thus be configured to provide four sub-arrays, with each sub-array having four radiating elements operating at 4G and/or WiFi frequencies. Frequency selective couplings such as meanderlines may be used to connect the patches in each sub-array together, so that they are responsive at other frequency ranges such as at 3G frequencies lower than the 4G frequencies of each patch 1000. Here, the four elements adjacent one another on the upper left may be shorted together by the frequency selective couplings. Likewise, the other three groups of four elements may be shorted together. The result is a four element orientation-independent array responsive at the lower frequency range.

Other frequency selective couplings can ensure the 16 patches are all shorted together at other frequencies, to provide an effective single conductive patch. This configuration may be used at AM/FM frequencies.

This conformal, multi-nested array configuration can provide operation across 600 MHz to 3800 MHz range as will be evident in more detail below. Hemispherical or monopole patterns can be provided as well as multiple and simultaneous antenna beams. Direction, polarization and spatial Multiple Input Multiple Output (MIMO) capability can also be provided.

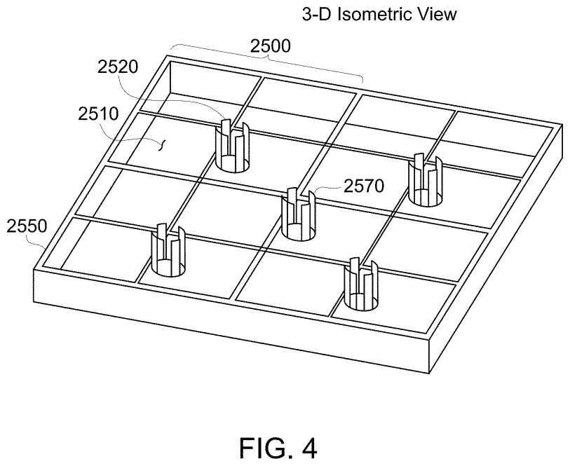

FIG. 4 shows the planar array configured for operation in frequency bands such as 700-900 vMHz or 3G cellular. In this mode, each group 2500 of four radiating elements 2510 is combined with the meander line structures as per FIG. 2A. Here, however, each of these subassemblies are then fed with a respective feed structure 2520 disposed beneath the reference plane 2550. The four feeds individually excite the four radiating elements. A center feed 2570 may also provide a unidirectional mode.

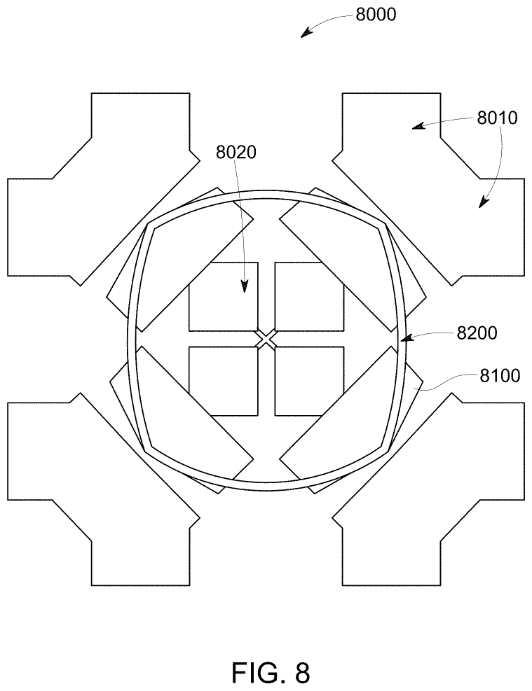

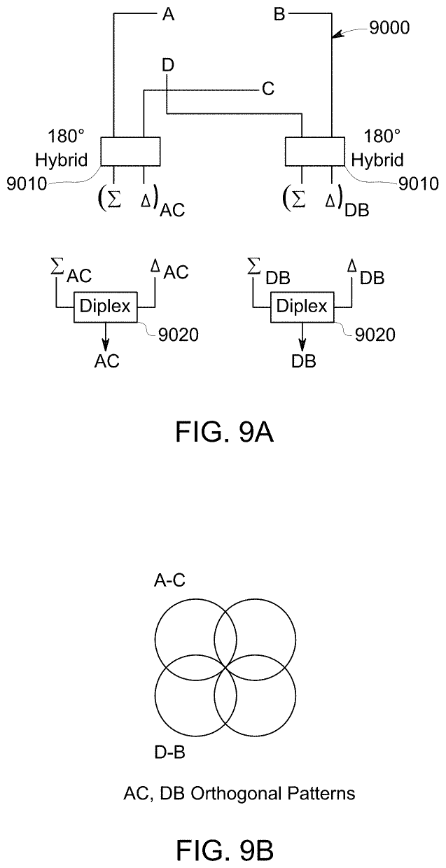

It is also possible to provide directional operation of the CALPRO by generating simultaneous directional beams using the combining networks shown in the referenced patent applications. Optional polarization switch matrices may be used to provide each of a right hand circular (RHCP) and left hand circular (LHCP) polarization part. Each polarization matrix may be as described in our co-pending U.S. patent application Ser. No. 15/362,988 (with specific reference to the switch matrix configurations in FIGS. 8A-8C and FIGS. 9A-9H therein) and which is hereby incorporated by reference.

If seperate polarization networks are provided for each of the right hand (RH) and left hand (LH) polarization, the respective outputs from the A, B, C, and D patches can each be applied to a respective combining network to simultaneously generate both RH and LH modes in the N, S, E, W directions.

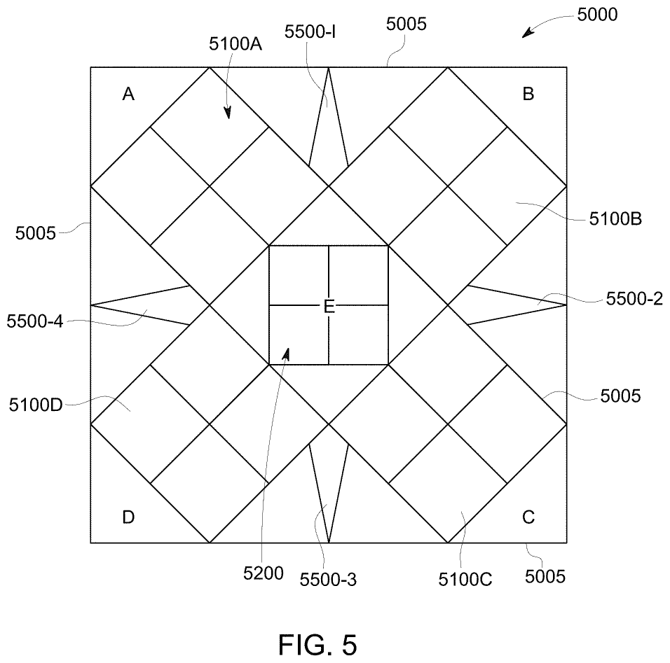

FIG. 5 is another implementation 5000 where a conformal, low profile antenna structure consists of a set of five unit cells disposed over the cavity. Here, four of the unit cells 5100 (5100A, 5100B, 5100C, 5100D) are still arranged on the periphery of the structure, but with the unit cells now diagonally juxtaposed. That is, each unit cell 5100 still consists of four patches, but each cell 5100 is now rotated such that the sides of the patches are at a 45 degree angle with respect to the tops of the sides 5005 of the rectangular cavity. A fifth unit cell, 5200E, may be disposed in the center of the other four unit cells, with its edges aligned with the sides of the cavity. In other words, the conductive patches of the center unit cell 5200E are rotated 45 degrees with respect those in the outer four unit cells 5100A, 5100B, 5100C, 5100D. As with the embodiments decribed in the other patents and patent applications referenced herein, a number of frequency selective coupling elements 5500 (such as meanderlines or other couplings) may connect the patches in each unit cell (not shown in FIG. 5) to one another and/or to the surrounding conductive surfaces, which may be the surfaces of a vehicle. These selective couplings are for tuning the structure across many different frequency bands.

If present, the fifth unit cell, 5200E, in the middle, increases coupling between the diagonally juxtaposed unit cells (A and C and B and D). Unit cell 5200E may be sized and used for coverage in SDARS, GPS, or GLONASS positioning system applications providing right-hand, left-hand and/or vertical polarization if desired.

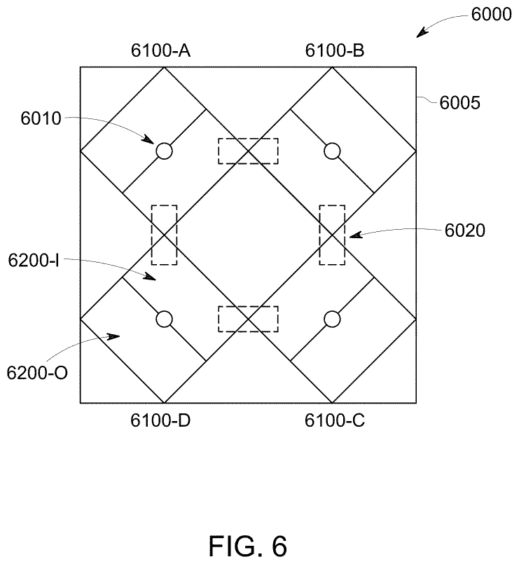

FIG. 6 is another implementation 6000 where each of the four array elements 6100-A, 6100-B, 6100-C, and 6100-D are again rotated 45 degrees with respect to the cavity walls 6005. However, now each of the four array elements 6100 consists only of two rectangular patches instead of four patches. An example array element 6100-D thus consists of an inner patch 6200-I and an outer patch 6200-O (e.g., there are a total of 8 radiators in the 4-element array). A feed point 6010 for each element is provided near where the inner and outer rectangular patches meet.

Also in this implementation, instead of meanderlines, capacitive couplers 6020 are disposed between each element and its two immediate neighboring elements, for example, where their respective inner patches nearly touch. It should be understood that capacitive couplers 6020 can also be used between the patches and the cavity, instead of meanderlines, in the other CALPRO configurations.

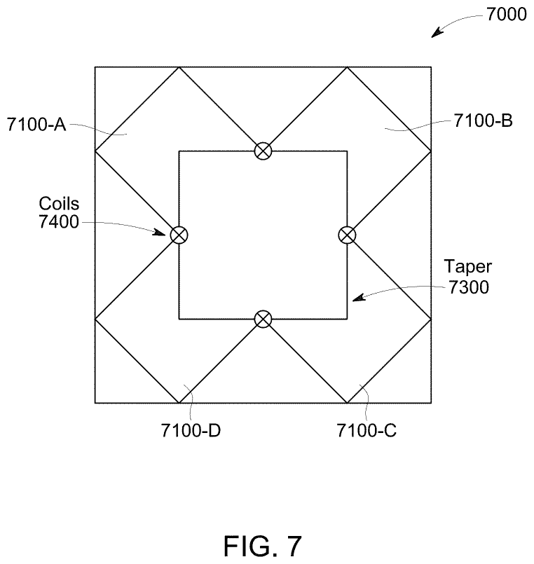

FIG. 7 is an array 7000 similar to the implementation of FIG. 6 but with still other differences. First, a bi-linear taper 7300 is added to one side of inner patches of each element 7100-A, 7100-B, 7100-C. and 7100-D. In other words, the inner patches here now have a five-sided, rather than rectangular, shape. The taper 7300 added to one side of each patch 7100 reduces the VSWR above 3 GHz to less than 3:1.

Another difference with FIG. 7 is the substitution of coils 7400 for the capacitors across the nearly touching inner points of adjacent array elements 7100-A, 7100-B, 7100-C, and 7100-D. The coils 7400 provide capacitance across the above points at the low frequencies 600-970 MHz and add series inductance at the higher frequencies. This in turn mitigates the shorting effect of the capacitors at frequencies such as between 1000-3800 MHz.

FIG. 8 is an implementation of a four unit cell 8100 low profile conformal array 8000 similar to FIG. 6 or FIG. 7, but with the addition of another structure to each unit cell 8100 that we call eigen arc wires 8200. The eigen arc wires 8200 replace the capacitive/inductive couplings shown in FIGS. 6 and 7. The eigen arc wires, each being a thin conductive arc of a generally circular shape (where the radius of the circle is about 4 to 5 times the width of the array), facilitate optimization of the coupling between the four array elements (A,B,C,D). Ideally, coupling in the 600-970 MHz band wants to be mainly capacitive, while the coupling in the 1700-3800 MHz band wants to be mainly inductive. The eigen arcs 8200 can address this requirement, with optimum ratio of capacitance to inductance in the two bands being determined by adjusting the thickness of the eigen arcs 8200. For operating in these two bands, and for the overall 5″×5″×0.625″ array geometry, we have found an eigen arc thickness of about ⅛″ to typically be suitable.

Also shown in FIG. 8 is the addition of two conductive planar flaps 8010 at the edges e.g., outboard of each outer radiator 8200. The flaps 8010 tends to remove a notch in the frequency response at the low end, by increasing capacitance between the array and the sides of the cavity.

The FIG. 8 implementation also includes a second smaller array 8020 of four patch elements which may be disposed in a different layer of a substrate from the conformal low-profile array, such as a different layer of a printed circuit board. The second array 8020 may provide operating in another higher frequence band, such as GPS, WiFi, S-STARS and the like.

FIG. 9A is a block digram of a combining network 9000 that may be used with any of the conformal antenna structues of FIG. 2A, 4, 5, 6, 7, or 8 to generate wide band “figure of eight” patterns from the diagonally situated element pairs A-C and D-B. The combining network 9000 provides for 2×2 MIMO applications.

The figure of eight patterns may be created by feeding the element pairs AC and DB into respective 180 degree hybrid combiners 9010. The difference outputs of the combiners form the figure of eight patterns A-C and D-B at the low frequencies 600-970 MHz, while the sum outputs generate the figure of eight patterns A-C and D-B at the high frequencies, 1000-3800 MHz. Diplexers 9020 may be used to combine the high and low frequency orthogonal pairs (the sum and difference outputs from each 180 degree combiner) into two wires to provide the wideband AC, DB orthogonal pairs, and resulting in the selectable antenna patterns of FIG. 9B.

It might be noted that the use of sum or difference excitation depends upon the spacing of the elements pairs. For small spacings efficiency is optimized by in-phase excitation, while at wider spacings, efficiency is optimized by out of phase excitation.

Vehicle Mounting Options

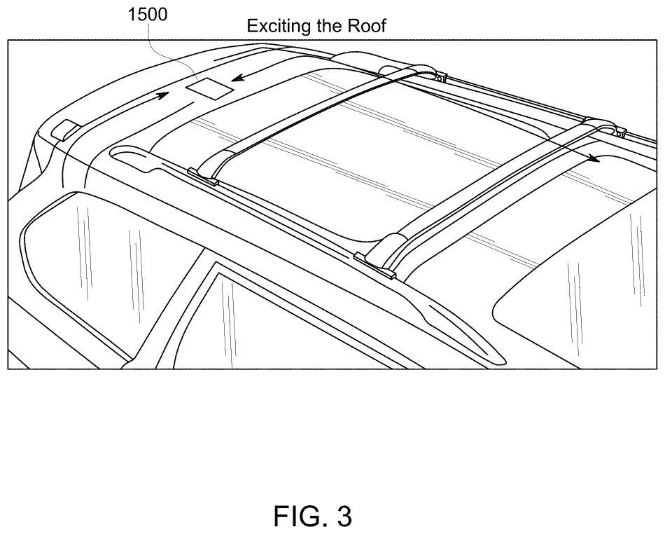

As explained previously, the conformal antenna arrays of FIGS. 1-8 may typically be mounted within or below the surface of a vehicle body panel such as a roof, hood, or trunk. The installation of the array may be conformal to the roof surface by placing the array in a cavity formed in the roof. An alternate arrangement is to place each subarray, or even each radiating element, in its own respective cavity.

The cavity or cavit(ies) may be formed by cutting out a section or section(s) of a metal vehicle body panel and covering the cavity with a cover or insert that conforms to the rest of the panel surface. The insert should be formed of a radio frequency transparent material such as plastic, fiberglass or some other dielectric. In other embodiments, the entire body panel may itself be formed of a uniform sheet of plastic, fiberglass or some other dielectric material.

In other implementations, the conformal array may be embedded in a transparent body panel such as a glass or plastic moonroof. In that configuration, the radiative surfaces of the antenna elements may be formed of an optically transparent, conductive material such as Indium Tin Oxide (ITO), metal coated glass, graphene film or the like.

Helical Element Inside Cavity for AM/FM

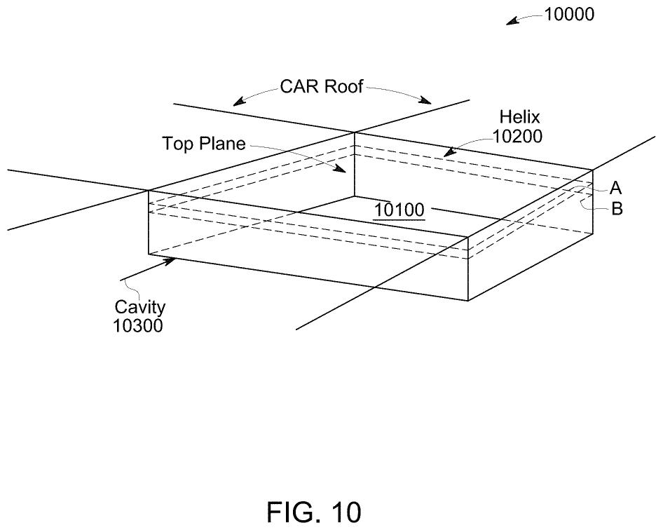

As shown in FIG. 10, another implementation of the conformal antenna 10000 includes an AM/FM antenna 10100 consisting of a helix 10200 of insulated wire on or near the inside walls of the cavity 10300. The AM/FM helix antenna may fed between two respective end terminals A,B with a balun (not shown). It generates a mainly vertically (V−) polarized wave with a small horizontal (H−) component. When disposed within the roof of a vehicle, the antenna creates one or more currents on the roof of the vehicle, which can then further excites the roof pillar regions of the vehicle, thus increasing the effective area.

One example implementation was a device contructed where the dimensions of the cavity were 5 inches×5 inches×0.625 inches. About 20 turns of #28 insulated copper wire spaced adjacent to the respective interior walls of the cavity were used to implement the helix. With those dimensions, resonant coverage was provided by the helix in the FM band (88-108 MHz), and the Digital Audio Broadcast (DAB) band (174-240 MHz).

Gain in the FM band was measured for that example implementation, as mounted on the roof of a vehicle, at −5 dbi. The AM sensitivity was also measured with an incident field of 60 db above 1 microvolt per meter, to be 39 db above one microvolt.

It should be understood that AM/FM helix shown in FIG. 10 may be used with or without any of the low profile, conformal antenna structures of FIG. 1, 2A-2D, 4, 5, 6, 7, or 8.

Smart Antenna Integrated with Electronics Subsystems

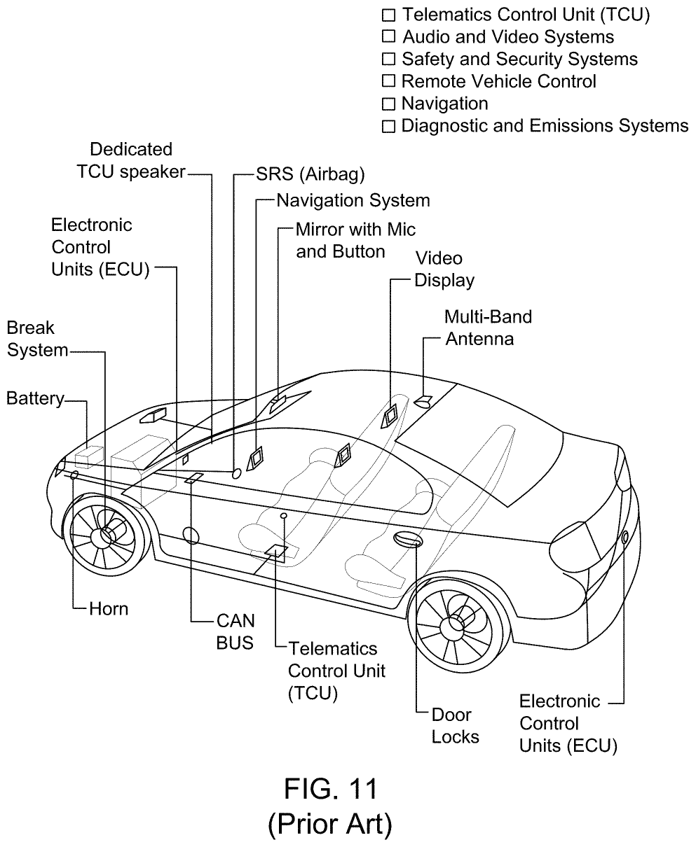

Electronics subsystems are now a part of almost all motor vehicles. As shown in FIG. 11, the electric door locks and mirrors widely adopted in passenger cars in the 1960's and 1970's were followed by Electronic Control Unit (ECUs) to manage powertrain and emissions components in the 1980's and 1990's. In the past 25 years, more sophisticated electronics subsystems such as diagnostics, airbag controllers, cruise control, integrated audio systems, media players, and video displays, safety and security systems, navigation systems, integrated cellular telephones and the like are now quite common as well.

A controller component often referred to as the Telematics Control Unit (TCU) is now present in most vehicles. The TCU includes one or more data processors, signal processors, and data storage devices to orchestrate the operation of these electrical and electronic subsystems. Practical applications of vehicle telematics can help improve the efficiency of functions such as navigation, vehicle tracking, active cruise control, remote control over door unlocking and heating/cooling systems, smartphone connectivity, infotainment, warning systems, intelligent vehicle functions, and even autonomous (self-driving) operation and many other functions.

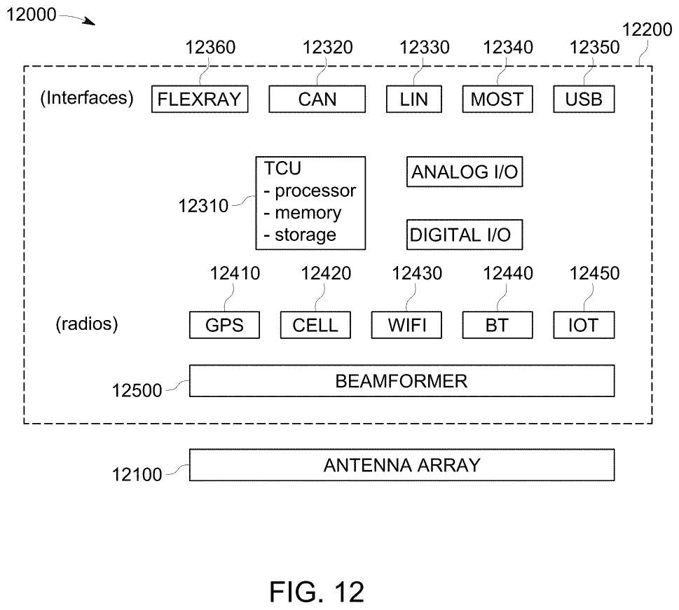

FIG. 12 is a functional block diagram of an integrated assembly 12000 that includes a housing with both the volumetric, multi-function, multi-band antenna subsystem 12100 described herein and integrated electronics 12200. The electronics 12200 integrated with the antenna subsystem may include, in one example, a TCU 12300 having (a) high-speed CAN bus(es) 12320 to communicate with the engine, transmission, powertrain, and related sensors, (b) a FlexRay interface 12360 to chassis components such as electronic steering, airbags and braking subsystems, (c) a LIN bus 12330 interface to body control subnetworks such as the instrument cluster, climate control and door locking systems. The TCU 12310 may also connect to and controls (d) infotainment subnetworks (such as via a MOST bus 12340, USB 12350, or in other ways) such as audiovisual, navigation (GPS) 12410.

Wireless communication subsystems (cellular 12420, Bluetooth 12440, WiFi 12430, NFC, IoT 12450 and similar systems) may also be included in the electronics 12220. These wireless subsystems all require some sort of antenna to operate. In the improved approach shown in FIG. 12, the TCU may further control operation of the antenna subsystem 12100 and associated beamformer 12500 to provide directional transmission and reception modes, orientation and polarization independent operation, direction and range estimation, and other features helpful to operation of the wireless communication components.

In some implementations, the antenna array 12100 is connected to the TCU 12310 through a control interface (such as the MOST 12340 or USB bus 12350). The TCU may also control the operational state of the beamformer 12500. The TCU controls the state of the antenna elements and the beam former according to particular desired operating conditions.

The result provides better control over and improved radio links to external wireless communication networks such as remote GPS, cellular, Wi-Fi, Bluetooth, NFC and other devices.

Antenna Mechanically Integrated with TCU

In one embodiment, the antenna array 12100 is a module that interfaces with and RF distribution board on which a TCU or other electronics are mounted. In another embodiment, a single housing subsumes both the antenna and the electronics. In another embodiment the electronics are disposed on a flexible circuit assembly that surrounds the antenna on one or more sides taking advantage of the surface area of the volumetric antenna, and locating the RF feeds in the most efficient locations. For example, Low Noise Amplifiers (LNA's) and/or filtering can be located on the circuits outside of the antenna enclosure ensuring that the optimal shielding is provided

Dual Modules

In one embodiment the antenna 12100 is a module that interfaces with an electronics RF distribution board using a blind mate single use interface such as a permanently soldered coaxial pin. Blind mate RF connectors are used primarily in situations where electronic hardware is required to be connected in limited spaces and/or access. The connector may take the form of a single coaxial connector or have multiple connectors built into a single housing.

The connection can be made using a push-on connection. The connector could require a minimal amount of force to engage and disengage the connection. The force requirement may drive the type of connector needed. Additionally, the connector may require a mechanism to keep the mated connectors intact.

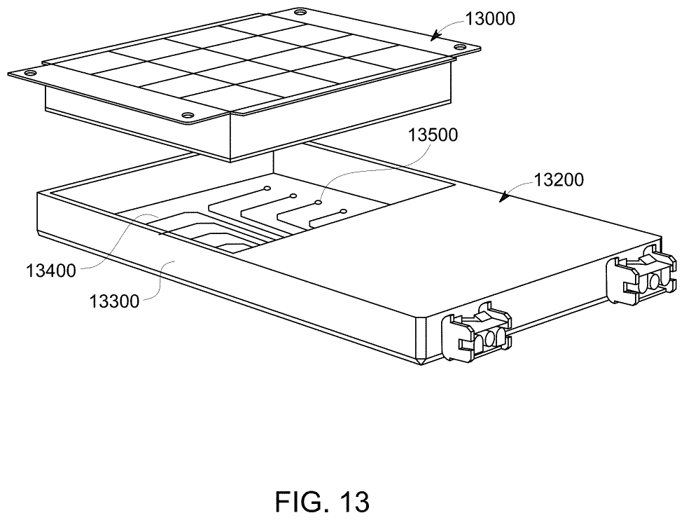

In some arrangements, as shown in FIG. 13, the antenna module 13000 may connect to an electronics module 13100 (which may encompass the TCU only, or other electronics shown in FIG. 12, or both) using an RF connector described above within a housing 13300. The antenna module 13000 can be configured to also interface with the conductive tracks 13400 and any other components on a printed circuit board 13500. These other components include electrical components, pads, or other features soldered on to the board 13500. A modular approach allows for easy repair or replacement of the modules 13000 and 13100 independent of one another. A nonoperational antenna 13000 or electronics 13100 module can be removed for repair or replaced without affecting the other module. It is envisioned that other attachments for the mechanical and/or electrical connections between the Antenna module 13000 and electronics 13100 are possible.

Antenna Integrated with Other Electronics

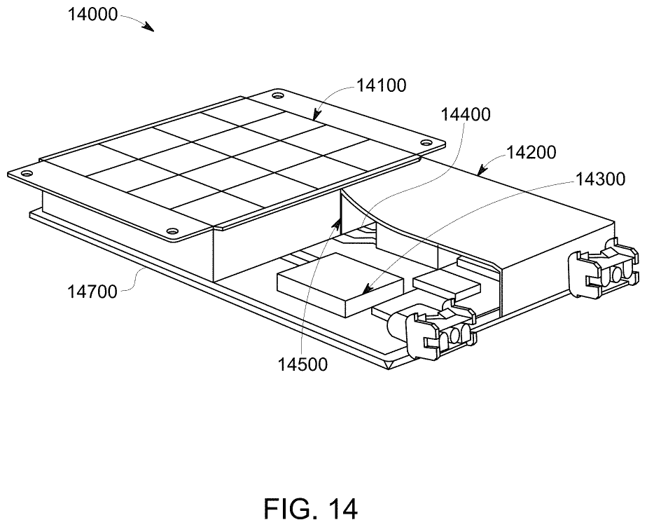

Another embodiment 14000 of the integrated antenna subassembly 14100 and TCU subassembly 14200 is that the antenna is built with some of the other electronics integrated as part of the antenna module 14100. For example, the cellular, WiFi, LTE, 5G, GPS, etc. radio and/or related components 14300 may be integrated in the same subassembly as the antenna module 14100. This requires the selected electronics components (such as radio receivers, transmitters, filters and the like) to be manufactured and integrated with the antenna module 14100. Other subassemblies, such as the TCU 14200, can then reside in a separate module 14200. The subassemblies may be integrated in a single common housing or some of the components may be in other enclosed modules 14500 that are mounted on the same base 14700; the base 14700 may also include circuit board traces that provide interconnects between modules. FIG. 14 is an example of this approach.

Wrap Around Electronics

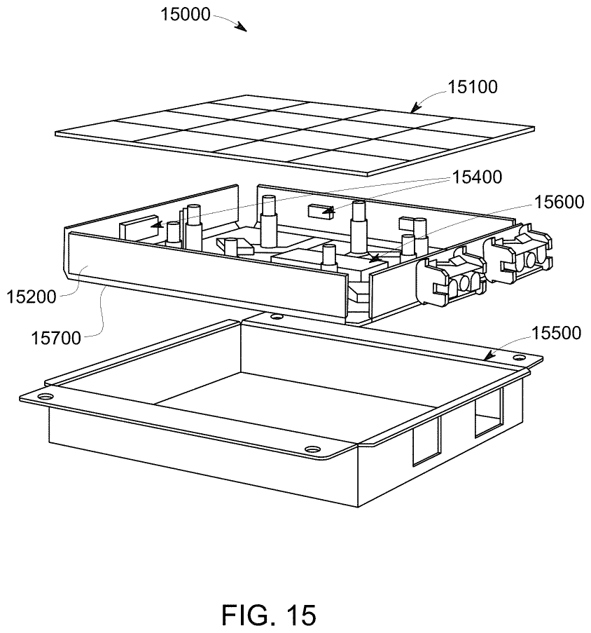

Another embodiment 15000 is depicted in FIG. 15. Here the electronics would be disposed on a flexible circuit assembly 15200 that surrounds the antenna subassembly 15100 on one or more sides taking advantage of the surface area of the volumetric antenna elements, and locating the RF feeds in the most efficient locations. For example, analog RF connections, LNA's and filtering components could be located as the circuits 15400 shown outside or outboard of the antenna enclosure 15100 but still located within the inner walls of the housing 15500, ensuring that the optimal shielding is provided. This configuration would eliminate most of or all of the discrete connectors between circuit boards. This wrap around configuraton provides another approach to integrating the antenna 15100 with the electronics. The digital and/or other control electronics 15600 may be further attached to flex circuit interconnect material, sitting below the antenna, that may be mounted on a printed circuit board 15700.

Antenna Mounting and Ground Plane Considerations

Certain embodiments of the antenna array, as described elsewhere in this application, are operational without a ground plane. This allows for the antenna to be positioned in places inside of a vehicle, and for example, mounted directly to glass. It should be understood that “vehicle” could mean any type of transportation vehicle, including but not limited to boats, trucks, cars, commercial, construction, etc. In one embodiment, the antenna can be mounted directly to a glass sunroof or window, since the need for a flat horizontal conducting surface is eliminated. However, in other cases where a ground plane is needed, an indium tin oxide (ITO) conductive coating could be used on the glass sunroof or window installation to serve this function.

Mechanical Attachment

The antenna can thus attach to the interior glass of a sunroof or any other glass surface in a vehicle. The attachment could be accomplished with a commercial grade adhesive or other mechanical means. Pre-drilled holes or other mechanical attachments could be pre-molded into the glass. It is preferable that the antenna is designed so that it is not visible when looking at the vehicle. This can be done if the antenna is designed blend in with glass tinting or with speckled patterns.

Electrical Connection

To provide electrical connections to the antenna, traces can be etched in the glass of the sunroof or other glass surface to which the antenna is mounted. The traces may connect directly to the antenna or branch off the antenna to form a T. The electrical connections can then also be coupled to the vehicle's roof pillars and energize the pillars as described in U.S. patent application Ser. No. 15/861,749 filed Jan. 4, 2018 entitled “Low Profile Antenna—Conformal” and/or U.S. patent application Ser. No. 15/838,465 filed Dec. 12, 2017 entitled “AM/FM Directional Antenna Array for Vehicle”, each of which are incorporated by reference in their entirety.

The integrated antenna and electronics assemblies described above convert RF signals into digital information entirely within a Smart Antenna unit. Thus, external electrical connections need not carry RF signals, which in turn reduces complexity over more conventional approaches. The conductive traces can now be DC signal lines such as used for simple resistive defroster wires in glass. These lines could be discrete wires or a bus structure such as Ethernet or a CAN bus. The wires could be made of standard conductor or with Indium Tin Oxide (ITO) similar to the material used in touch screens. Further advancements would use carbon nanotubes as the conductors to minimize size and signal losses.

Light Assembly

In another embodiment, the antenna is part of the vehicle's overhead light assembly. An aperture in the roof can allow the antenna to have an opening to outside of the vehicle. The antenna can also be attached as part of a dome light or a map light, such as with the antenna configured to sit between two bulbs or it could be part of single light configuration. The overhead light could be in a circular or rectangular shape. Such an overhead light assembly may also provide power needed for the antenna or associated electronics operation. By concealing the antenna and/or integrated antenna and electronics/TCU in the light assembly, full functionality is provided while preserving the vehicles external aesthetic appearance.

Other Embodiments

In another embodiment, the antenna could also take an ornamental or decorative shape or design. The antenna could be of any shape or color to integrate with the style or color of the vehicle's interior. By incorporating the antenna into the overhead console or entertainment unit, the antenna/TCU package can be hidden from sight and located close to the unit for presenting the information to the passengers.

Conformal Antenna Array Alternatives and Use Cases

The antenna array may be implemented as any of the low-profile, conformal, steerable, and/or orientation-independent (ORIAN), and/or Multiple Input Multiple Output (MIMO) antennas described in our co-pending U.S. patent applications as follows:

Ser. No. 15/903,115 filed Feb. 23, 2018 entitled “Directional MIMO Antenna” (Attorney Docket Number 111052-0093U), and Ser. No. 15/861,749 filed Jan. 4, 2018 entitled “Low Profile Antenna—Conformal” (Attorney Docket No. 111052-0095U) and Ser. No. 15/861,739 filed Jan. 4, 2018 entitled “Indoor Positioning System Utilizing Beamforming with Orientation- and Polarization-Independent Antennas” (Attorney Docket Number 111052-0089U), each of which are hereby incorporated by reference in their entirety.

In some use cases, the vehicle may operate as the “beacon device” described in those patent applications with the remote devices (or “tags”) instead being a remote cellular site, Wi-Fi access point, remote Bluetooth or IoT transceiver, GPS transmitter or the like. The database maintained to retain user information, location maps, analytics derived from collected location data and other information may be the TCU's own internal electromagnetic or solid-state data storage devices.

As also explained in those patent applications, the antenna array may take physical several forms including a number of cylindrical radiating elements with a center driven element and one or more surrounding or selectively parasitic elements. The antenna array may also be composed of sets of super directive, end fire line arrays of volumetric patch antennas as also described in the referenced patent applications. Each array radiator may itself consist of a pair of crossed dipoles formed from four radiators or sections of radiators, with their feed points connected in pairs as described in the referenced patent application.

The net effect is that the antenna subsystem can be controlled by the TCU (which may be integrated with the same assembly or housing), to steer an antenna beam along X, Y, and Z axes in any desired direction. In addition, the transmitted and received signals of interest may have both horizontal and vertical polarization components in any direction.

The beamforming circuits used with the TCU may be the same or similar to the beamforming circuits described in the referenced patent applications. The resulting signals from the hybrid combiners in these beamforming circuits can be further processed to certain signals representative of both the azimuth and elevation that are independent of any horizontal or vertical component.

Additional functionality can be provided by the beamforming circuit such as null steering.

The TCU, cooperating with the antenna array, can also provide direction finding functions. As explained in our other above-referenced patent application(s), this can be accomplished by initially scanning through a subset of beam directions in both azimuth and elevation with relatively wide beams, with subsequent scans being made with higher accuracy through selectively narrower beamforming. The resulting narrow beams can enable a stereoscopic direction finding or triangulation mode which enables a way to estimate range. As now also understood, the antenna array(s) can be operated by the TCU to estimate a distance as well as an angle of arrival. For example, accurate elevation angle, azimuth angle and polarization of the incident plane may be determined using the polarization independent algorithms described in the above-referenced patent application(s). Since the remote devices can be estimated to be on the ground (or when other elevation information is available), theta, phi, and H are all that are needed to determine location in three dimensions of line of sight targets.

Targets which are not in a direct line of sight to the antenna array, may be hidden (for example, the acquisition of energy by the antenna from a remote device may be due to a reflection off of an adjacent building). In one approach, with the cellular or WiFi receiver operating a cooperative protocol that reports receive signal strength back to the antenna array, that information for beams emitted in different directions by the array (or from different arrays) may resolve position ambiguities (such as by selecting the strongest received signal).

However, an estimate of the location of a target can also be made by using geometric ray tracing, physical optics ray tracing or using an electromagnetic modeling program such as High Frequency Electromagnetic Field Simulation (HFSS) software available from ANSYS, Inc. of Canonsburg, Pa. The high accuracy provided by the direction of arrival processing enhances the result of these ray tracing methodologies. These schema typically require an accurate representation of the geometry of the surrounding environment with its buildings and other reflective and absorptive structures. In some implementations, a last known position of a remote device may also be used to resolve ambiguities.

If scattering of the target electromagnetic waves is polarization dependent (i.e. cell phone orientation), then a calibrating mode of operation may be used where target devices are moved about an area and three orthogonal polarizations in the x,y,z directions can be generated. The data base, for each target location, will then have three components of incident plane wave information from the ORIAN, (theta, phi, polarization), for each of the three x,y,z target polarization vectors. The data base containing these three vectors for all the target locations thus calibrated can then be correlated against the received vector (theta, phi, and polarization) from the ORIAN for each acquisition and measurement event during store hours. The maximum correlation indicates which target location is valid. The ray tracing methodologies may also take into account polarization since the array can measure the polarization of the incident wave.

In other aspects, this arrangement enables the TCU to perform functions that may depend upon distance to the remote device. The beam former may also be manipulated to inform the TCU as to which recipient device is providing the strongest signal and thus which is more advantageous to use according to observed conditions. For example, the TCU may select one of several nearby cellular base stations or WiFi access points to communicate with, based on the range determination. In another mode, the TCU may operate the WiFi and cellular radios in a dual mode configuration, and only connect to the cellular network when a sufficiently strong and/or close WiFi signal is not available. In still other aspects, the TCU may participate in handoff decisions between adjacent cellular base stations and/or WiFi access points.

The antenna array may also be implemented as any of the arrays described in our co-pending U.S. patent application Ser. No. 15/861,749 Filed Jan. 4, 2018 entitled “Low Profile Antenna-13 Conformal” (Attorney Docket Number 111052-0095U), already incorporated by reference herein.

While various apparatus and methods have been particularly shown and described with references to example embodiments thereof, it will be understood by those skilled in the art that various changes in form and details may be made therein without departing from the scope of the invention(s) encompassed by the appended claims.

What is claimed is:

1. An antenna for use in a vehicle comprising:
a rectangular cavity having conductive walls,
a plurality of radiating elements disposed in a reference plane located above the cavity, such that each radiating element comprises a planar surface having four or more sides, with groups of two or more radiating elements forming an array and further disposed in a defined pattern such that at least one side of a selected radiating element in a given array is aligned at an angle less than 90 degrees with respect to an upper edge of at least one of the conductive walls.

2. The antenna of claim 1 additionally comprising:
a plurality of couplings, each coupling disposed between a respective one of the radiating elements and the other radiating element or a ground plane reference point.

3. The antenna of claim 1 additionally comprising:
a wire helix, disposed below the reference plane and within the rectangular cavity.

4. The antenna of claim 1 additionally wherein:
the cavity is disposed below a body panel of the vehicle.

5. The antenna of claim 1 additionally wherein:
two or more sides of the radiating elements in each array element are positioned at a 45 degree angle with respect to an upper edge of the cavity walls.

6. The antenna of claim 1 additionally wherein:
at least one radiating element in each array element has an interior side that is tapered.

7. The antenna of claim 1 additionally wherein
the ground plane element comprises one or more outer ground plane surfaces, disposed outboard of and adjacent to the radiators, and disposed in line with or below the reference plane.

8. The antenna of claim 2 wherein the couplings are at least one of a capacitive, inductive, or a frequency-selective impedance.

9. The antenna of claim 1 wherein
the plurality of radiating elements are disposed in a reference plane located above the cavity, such that each radiating element comprises a planar surface having four or more sides, with groups of two or more radiating elements comprising an orientation independent array element, to provide a total of four array elements A, B, C, D; and
with the radiating elements further disposed in a defined pattern such that at least one side of a selected radiating element is aligned in parallel with a least one side of another radiating element of each array element, and also disposed within the reference plane; and
a combining network comprising:
a pair of 180 degree hybrid combiners, for feeding respective array element pairs AC and DB;
a difference circuit, for providing a first set of figure of eight patterns AC and DB; and
a sum circuit, for proving a second set of figure of eight patterns.

10. The antenna of claim 9 additionally comprising:
another planar antenna array E, disposed between two or more of the array elements A,B, C, and D, dimensioned for radiating in a satellite positioning system frequency band.

11. An apparatus for use in a vehicle comprising:
a rectangular cavity having conductive walls,
a plurality of radiating elements disposed in a reference plane located above the cavity, such that each radiating element comprises a planar surface having four or more sides, with groups of two or more radiating elements forming a directional antenna subassembly;
an electronics subassembly;
the antenna subassembly and electronics subassembly each disposed and integrated into a single housing.

12. The apparatus of claim 11 wherein the electronics subassembly includes a Telematics Control Unit (TCU).

13. The apparatus of claim 11 additionally comprising:
a connector, disposed on an external surface of the housing, the connector providing conductors that carry digital signals.

14. The apparatus of claim 11 wherein the electronics subassembly includes one or more radio frequency transmitters or receivers.

15. The apparatus of claim 11 wherein the planar surface is disposed adjacent to or comprisesa a glass portion of a vehicle roof or a window.

16. The apparatus of claim 11 additionally comprising:
a printed circuit board PC located in a a lower part of housing and providing an interconnect between the antenna subassembly and the electronics subassembly.

17. The apparatus of claim 11 wherein selected components of the electronics subsassembly are mounted on a flexible circuit substrate surrounding at least part of the antenna subassembly.

18. An FM antenna for use in a vehicle comprising:
a cavity disposed below a body panel defining a reference plane;
a wire helix, disposed below the reference plane and within the rectangular cavity.
